(19) United States
(12) Patent Application Publication
(10) Pub. No.: US 2007/0296109 A1
(43) Pub. Date: Dec. 27, 2007

(54) BLOCK TUMBLER WITH BLOCK-IMMOBILIZING DEVICE

(76) Inventors: Francis Vezina, Varennes (CA); Sylvain Vezina, St-Charles sur Richelieu (CA)

Correspondence Address: LADAS & PARRY LLP, 224 SOUTH MICHIGAN AVENUE, SUITE 1600, CHICAGO, IL, 60604, US

(21) Appl. No.: 11/677,451

(22) Filed: Feb. 21, 2007

Related U.S. Application Data
(60) Provisional application No. 60/774,636, filed on Feb. 21, 2006.

(51) Int. Cl. B28B 11/08

(52) U.S. Cl. 264/162; 901/2; 901/30

(57) ABSTRACT

An apparatus for modifying the appearance of a surface-texture of cementitious blocks. The apparatus comprises a container, a movement imparting device and at least one block-immobilizing device. The container comprises block-receiving areas for receiving blocks. The movement imparting device imparts a movement to the container. The block-immobilizing device immobilizes the blocks on a given block-receiving area the during movement of the container. When introducing an impacting material in the container and imparting a movement to the container, the impacting material is caused to so impact the cementitious blocks as to modify the appearance of the surface texture thereof so as to artificially age these blocks. A vacuum device and a clamping device are also disclosed as block-immobilizing devices. Also disclosed herein is a method for modifying the appearance of a surface-texture of cementitious blocks so as to artificially age these blocks.

### CROSS-REFERENCE TO RELATED APPLICATIONS

The present application relates to U.S. Provisional Application No. 60/774,636 filed on Feb. 21, 2006, on which priority is requested and which is incorporated herein by reference in its entirety.

### FIELD OF THE INVENTION

The present invention relates to a tumbler for artificially ageing the appearance of pre-cast blocks. More particularly but not exclusively, the present invention relates to a block tumbler with a block-immobilizing device for maintaining blocks in place within the tumbler.

### BACKGROUND OF THE INVENTION

Artificially ageing the appearance of cementitious blocks is required since cementitious blocks such as concrete building blocks prepared by conventional manufacturing operations produce blocks that have a geometrically rectangular configuration with substantially planar surfaces and sharp edges.

Typically, in order to give these blocks a natural or stone-cut allure, they are introduced into a large tumbling drum. This tumbling drum or tumbler is rotated in order to cause tumbling of the blocks contained therein thus causing multiple random collisions between the blocks, thereby damaging the surfaces, edges and corners giving the blocks a worn, aged or natural stone cut appearance. Since these blocks are loose within the tumbler, once tumbled they are then dumped in a pile.

A drawback or piling the tumbled blocks is the amount of time and/or manual labor required to separate, sort and organize tumbled blocks. Another drawback of tumbling blocks as explained above is the amount of block material that is lost in order to produce the desired blocks.

### OBJECTS OF THE INVENTION

An object of the invention is to provide a tumbler for artificially ageing blocks.

Another object of the invention is to provide a tumbler for artificially ageing blocks with a block-immobilizing device for maintaining the blocks in place during tumbling.

A further object of the invention is to provide a tumbler for artificially ageing blocks with a vacuum device for maintaining the blocks in place during tumbling.

Yet another object of the invention is to provide a tumbler for artificially ageing blocks with a clamping device for maintaining the blocks in place during tumbling.

### SUMMARY OF THE INVENTION

In accordance with an aspect of the present invention, there is provided an apparatus for modifying the appearance of a surface-texture of cementitious blocks, the apparatus comprising: a container comprising block-receiving areas for receiving blocks; a movement imparting device for imparting a movement to the container; and at least one block-immobilizing device for immobilizing blocks on a given block-receiving area during movement of the container; wherein when introducing an impacting material in the container and imparting a movement to the container the impacting material is caused to so impact the cementitious blocks as to modify the appearance of the surface texture thereof.

In accordance with another aspect of the present invention, there is provided an apparatus for modifying the appearance of a surface-texture of cementitious blocks, the apparatus comprising: a container comprising block-receiving areas for receiving blocks; a movement imparting device for imparting a movement to the container; and at least one vacuum device for immobilizing blocks on a given block-receiving area during movement of the container; wherein when introducing an impacting material in the container and imparting a movement to the container the impacting material is caused to so impact the cementitious blocks as to modify the appearance of the surface texture thereof.

In accordance with a further aspect of the present invention, there is provided an apparatus for modifying the appearance of a surface-texture of cementitious blocks, the apparatus comprising: a container comprising block-receiving areas for receiving blocks; a movement imparting device for imparting a movement to the container; and at least one clamping device for immobilizing blocks on a given block-receiving area during movement of the container; wherein when introducing an impacting material in the container and imparting a movement to the container the impacting material is caused to so impact the cementitious blocks as to modify the appearance of the surface texture thereof.

In accordance with yet another aspect of the present invention, there is provided a method for modifying the appearance of a surface-texture of cementitious blocks, the method comprising: immobilizing blocks within a moveable container; introducing an impacting material in the container; and imparting a movement to the container so as to cause the impacting material to so impact the cementitious blocks as to modify the appearance of the surface texture thereof

The expression “modifying the appearance of a surface-texture” includes without limitation artificially ageing, scathing, abrading, scratching, breaking, the planar surface, the edges, and the corners of blocks and the like.

The term “cementitious blocks” includes without limitation concrete blocks, pre-cast blocks, pavers, bricks, and the like.

The term “impacting material” includes without limitation any material than when impacting with sufficient force the surfaces, edges, or corners of cementitious blocks will artificially modify or age the foregoing

The term “block-immobilizing device” includes without limitation any device, mechanism, machine, tool, assembly, means, apparatus, system, element, and the like of any kind within the context of the invention for immobilizing blocks on a block-receiving area of container that is to be so moved as to cause the impacting material therein to impact the blocks so as to modify the appearance of a surface-texture thereof

Other objects, advantages and features of the present invention will become more apparent upon reading of the following non-restrictive description of illustrative embodiments thereof, given by way of example only with reference to the accompanying drawings.

### BRIEF DESCRIPTION OF THE FIGURES

In the appended drawings, where like reference numerals indicate like elements throughout and where:

FIG. 1 is a perspective view of the block tumbler in accordance with a first illustrative embodiment of the present invention;

FIG. 2 is a lateral side view of the block tumbler of FIG. 1;

FIG. 3 is a front side view of the block tumbler of FIG. 1, the rear side being a mirror image thereof;

FIG. 4 is a top plan view of the block tumbler of FIG. 1;

FIG. 5 is a perspective front view of the block tumbler in accordance with a second illustrative embodiment of the present invention;

FIG. 6 is another perspective front view of the block tumbler of FIG. 1;

FIG. 7 is a further perspective front view of the block tumbler of FIG. 1;

FIG. 8 is perspective rear view of the block tumbler of FIG. 1;

FIG. 9 is a perspective view of the bock-receiving area and block-immobilizing device of the block tumbler of FIG. 1; and

FIG. 10 is another perspective view of the bock-receiving area and block-immobilizing device of the block tumbler of FIG. 1.

### DETAILED DESCRIPTION OF THE ILLUSTRATIVE EMBODIMENTS

Generally stated, the invention is concerned with a block tumbler apparatus that includes a rotating drum having internal surfaces, defining block-receiving areas, on which blocks are immobilized via a block-immobilizing device. In two non-limiting examples illustrated herein, the block-immobilizing device comprises a vacuum device or a clamping device. In this way, instead of tumbling the blocks together in a random fashion, an impacting material is inserted into the rotating drum and as the drum rotates, the impacting material impacts the blocks which are immobilized thereby modifying their surface-textures.

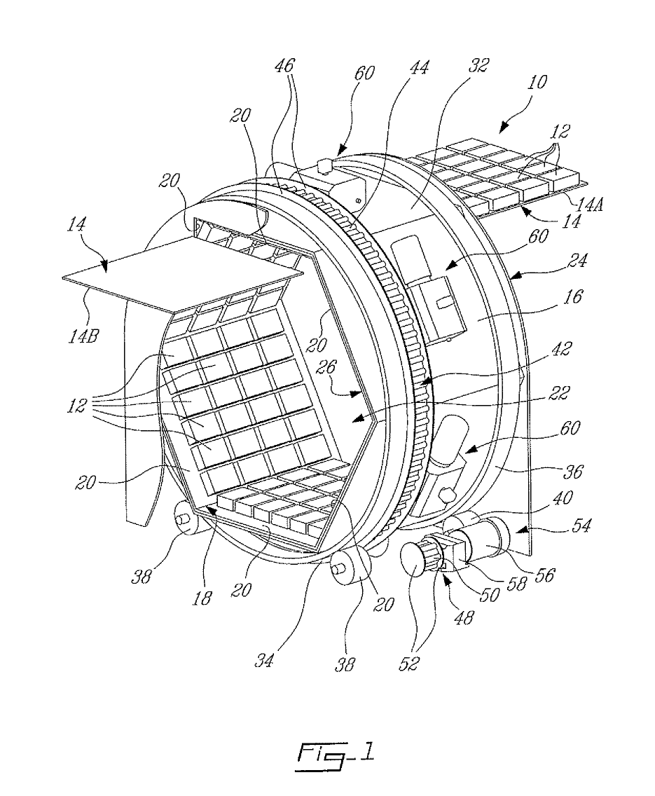

A first Illustrative embodiment of the present invention will be discussed in further details hereinbelow and with reference to FIGS. 1 to 4.

FIG. 1 illustrates an apparatus, hereinafter named a “tumbler” and generally denoted by numerical reference 10, for modifying the surface-texture of pre-cast blocks 12, thereby artificially ageing the appearance thereof.

The pre-cast blocks 12 may be any type of molded cementitious blocks such as concrete blocks, bricks, pavers to give but a few non-limiting examples. Blocks 12 may have different sizes and configurations and may be destined to be used as paving stones, bricks, steps, retaining walls and other like structures known in the art. Blocks 12 may be prepared by a variety of conventional processes such as casting, cutting, drying and the like. After a curing process these blocks have a generally rectangular geometric shape with substantially planar surfaces and substantially sharp corners.

The blocks 12 are placed on a platform, generally denoted 14 that is adapted to move the blocks 12. Platform 14 may comprise a conveyor, a moveable board, a robotic apparatus, a supporting platform with a push member to push the blocks 12 or any other device suitable in the art so as to infeed blocks 12 into the tumbler 10 and so as to out-feed blocks 12 from the tumbler 10. Of course, such platforms are well known in the art and need not be discussed further. The blocks 12 are typically arranged in a certain layout on the platform 14 which results from the prior processing operation. In the illustrated example of FIGS. 1, 3 and 4, there is shown an in-feed platform specifically denoted 14A and an out-feed platform specifically denoted 14B.

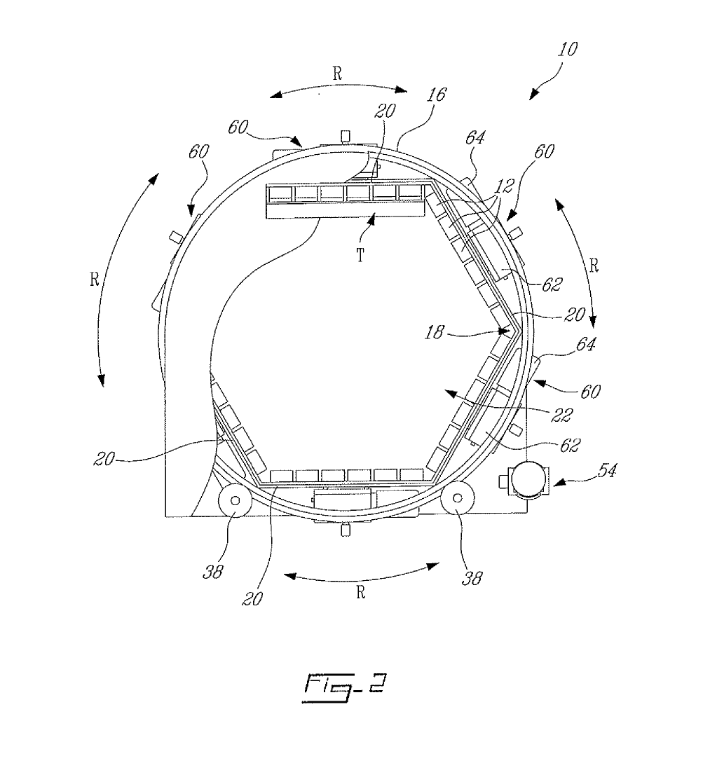

The tumbler 10 comprises a container 16 in the form of a drum that is rotatable in either a clockwise or counterclockwise direction as shown by arrows R in FIG. 2.

As shown in FIGS. 1 and 2, the drum 16 includes an internal peripheral surface 18 having substantially planar block-receiving areas 20. In the illustrated non-limiting example, there are six such block-receiving areas 20. Of course, the skilled artisan may contemplate a greater or lesser number of block-receiving areas 20 which depends on the size, length and general configuration of the drum 16 which can be modified by the skilled artisan within the context of the present invention. In another non-illustrated embodiment, each block-receiving area 20 can comprise a plurality of separate compartments for including a given block 12 therein.

The drum 16 also defines a working space 22, shown in FIG. 2, the object of which will be explained herein.

With respect of FIGS. 1, 3 and 4, the drum 16 also includes two open opposite lateral sides 24 and 26. Lateral side 24 is an in-feed for receiving blocks 12 and lateral side 26 is an outfeed side for removing blocks therefrom. Of course, sides 24 and 26 are generally mirror images of each other and blocks 12 can be fed in and out of the same side 24 or 26. The skilled artisan may find it more convenient to in-feed blocks in one side and out-feed blocks from the other side. Of course, the blocks 12 can be in-fed or out-fed from either side 24 or 26, this will depend on the uploading or downloading device that is used and on the general disposition of the working area in which the present tumbler 10 operates and other operational considerations known in the art.

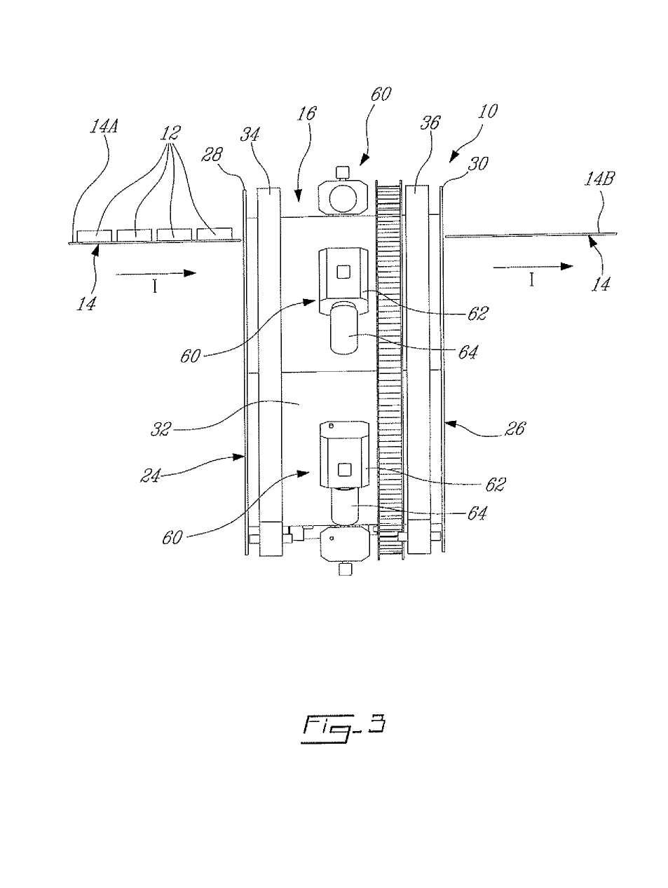

With reference to FIG. 3, lateral side 24 and 26 are respectively closed via tight-sealing doors 28 and 30. It is generally known in the art to close tumblers via doors coupled to the rotating drum, such as drum 16, via an actuator for operatively moving these doors between open and closed positions.

The drum 16 can be moved so as to rotate by a variety of movement imparting devices. In this respect and with reference to FIGS. 1 and 3, the drum 16 includes a frame 32 having rotating guides 34 and 36 near lateral sides 24 and 26 respectively. The rotating guides 34 and 36 5 respectively engage wheels 38 and 40. As shown in FIG. 1, the rotating drum 16 includes driven pulley 42 near is lateral side 26. The driven pulley 42 includes a track 44 between a pair of protruding guard members 46. Correspondingly, the tumbler 10 also includes a driving pulley 48 having a track 50 between a pair of guard members 52. The driving pulley 48 is powered to rotate by an actuator 54 shown including a motor 56 and a reducer 58. As is known in the art, a belt-strap (not shown) is mounted to the driving pulley 48 and to the driven pulley 42. Specifically, the belt-strap is mounted on tracks 50 and 44 and kept in place by guard members 52 and 46. Hence, the actuator 54 rotates the driving pulley 48 which acts on the belt-strap which subsequently acts on the driving pulley 42 thereby rotating the drum 16, as shown by arrows R in FIG. 2, via guide members 34 and 36 engaging the rolling wheels 38 and 40.

Rotatable drums for blocks are well known in the art and the skilled artisan may contemplate a multitude of alternative ways of rotating a drum 16 within the context of the present invention. The present example illustrates one of the many available ways of performing such an operation. In this way, a variety of actuators such as hydraulic, pneumatic or electric motors as well as driving mechanisms and the like can be used.

The block-immobilizing devices 60 of FIGS. 1-4 will now be discussed.

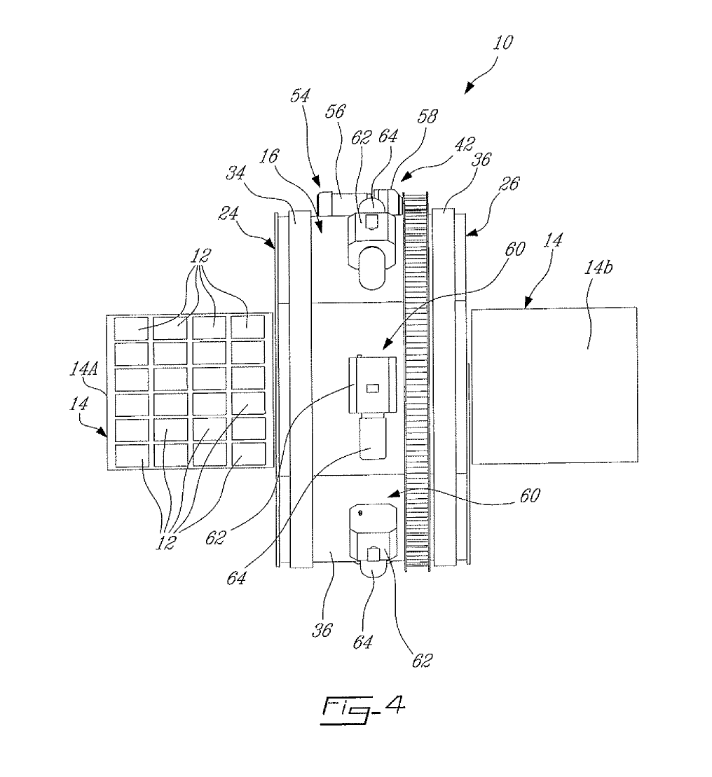

As shown in 1-4, the drum frame 32 includes block-immobilizing devices 60 in the form of vacuum devices. Referring now to FIGS. 3 and 4, each vacuum device 60 includes a suction 62 and a compressor 64 for creating a vacuum. Turning now to FIG. 2, the vacuum devices 60 are adjacent the block-receiving areas 20, in this way, the suction 62 is mounted through the drum frame 32 and via conduits (not shown) is in communication with each compartment (not shown in this example) of a block-receiving area 20. In this way, when blocks 12 are introduced sufficiently near a compartment and the vacuum device 60 is activated a given compartment sucks up a given block 12 and immovably holds it therein.

In operation, an in-feed platform 14A moves blocks inside the tumbler 10 beneath yet sufficiently close to the surface of a superimposed block-receiving area 20. The vacuum device 60 is activated and sucks up the blocks 12 thereunder. The in-feed platform 14A is then removed from the tumbler empty. In this example, platform 14B is the same as 14A except that it is empty since the blocks thereon were sucked. Hence, platforms 14 move in the direction shown by arrows I in FIG. 3. The drum 16 is then rotated in order for the next empty block-receiving area 20 top surface, generally denoted T in FIG. 2, in this case the drum 16 will rotate about 60°. Hence, T is the top position that each of the six block-receiving areas 20 will be brought to so as to bring a platform 14 with blocks 12 thereunder to be sucked onto area 20 via the suction force of vacuum device 54.

An impacting material (not shown) is inserted inside the drum 16. This impacting material may include concrete scrap or any other suitable material that the skilled artisan can contemplate for impacting the surface-texture of blocks 12 in order to artificially age them in appearance. The doors 28 and 30 seal the drum 16 and the actuator 54 acts on drum 16 to cause it to rotate while the vacuum devices 60 hold the blocks 12 in the block-receiving areas 20. In this way, the impacting material is tumbled within the working area 22 defined by the drum 16; this causes the tumbling impacting material to collide with the immovable blocks 12. These multiple collisions damage and modify the surface textures including corners and edges of the blocks 12 thereby imparting to the blocks an aged or worn appearance.

After the tumbling process, rotation of the drum 16 is stopped and doors 28 and 30 are opened An out-feed platform 14B enters the drum 16 and is positioned beneath blocks 12 at position T. The vacuum system 60 acting on the blocks 12 at position T is shut off and the blocks 12 fall on the platform 14B. The platform 14B is sufficiently close to the immobilized blocks 12 so that when they fall after suction ceases, they substantially retain their positioning on the platform 14B. The platform 14B with the modified blocks 12 thereon is removed from the drum 16 and a the drum 16 is rotated so that the subsequent block-receiving area 20 holding blocks 12, via vacuum is brought to position T until the drum 16 has been emptied. Of course, when a block-receiving area 20 is emptied of blocks 12 as explained above, a new batch of blocks 12 may be brought to this area 20 to be sucked by vacuum before rotating to the subsequent area 20 with immobilized blocks 12. In this way, blocks 12 are emptied from an area 20 and new blocks 12 fill this same area 20. Of course, the skilled artisan will use an approach block emptying and filling approach that is suitable to specifics needs and goals within the context of the present invention.

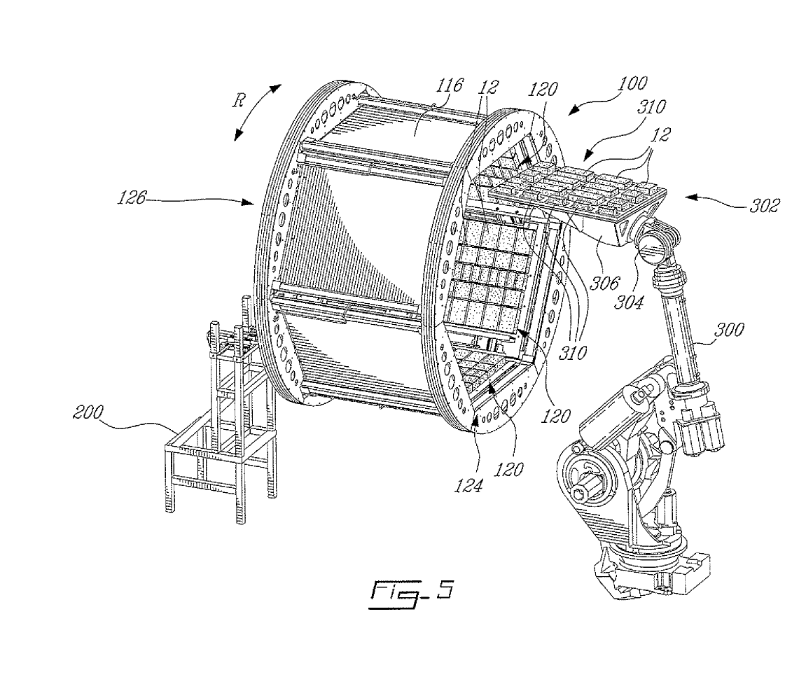

Referring now to FIGS. 5 to 10, a second illustrative embodiment of the present invention will be discussed.

FIGS. 5 to 10 show a tumbler 100 that is similar to tumbler 10. In fact, the principle operation of tumbler 100 is substantially the same to that of tumbler 10; what differs is the block-immobilizing device used by tumbler 100. Whereas tumbler 10 provided a vacuum device 60 as the block-immobilizing device, tumbler 100 provides a clamping device (which will be described herein). Hence, the description below will focus mostly, but not exclusively, on the differences between tumbler 100 and tumbler 10 for concision purposes only.

Therefore, keeping the foregoing in mind, FIG. 5 shows a tumbler 100 for modifying the surface texture of blocks 12. The tumbler 100 includes a container 116 in the form of drum which as previously discussed can be actuated in a variety of movement imparting devices as is known in the art so as to rotate in either direction of the arrow R.

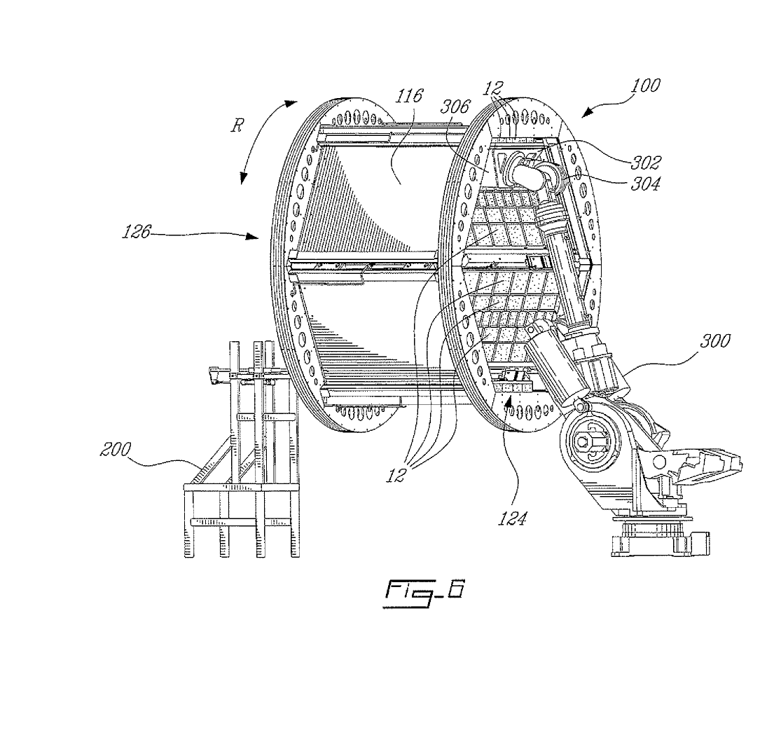

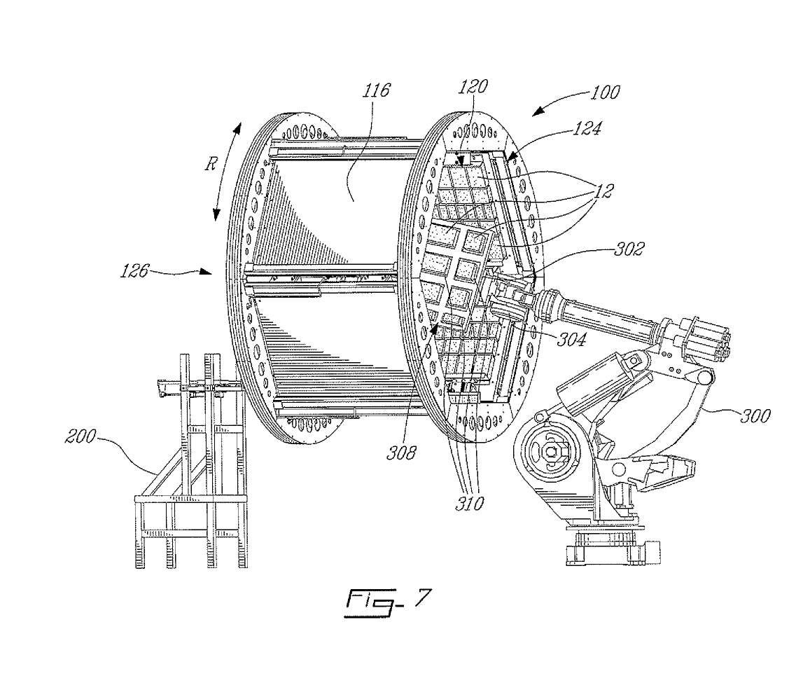

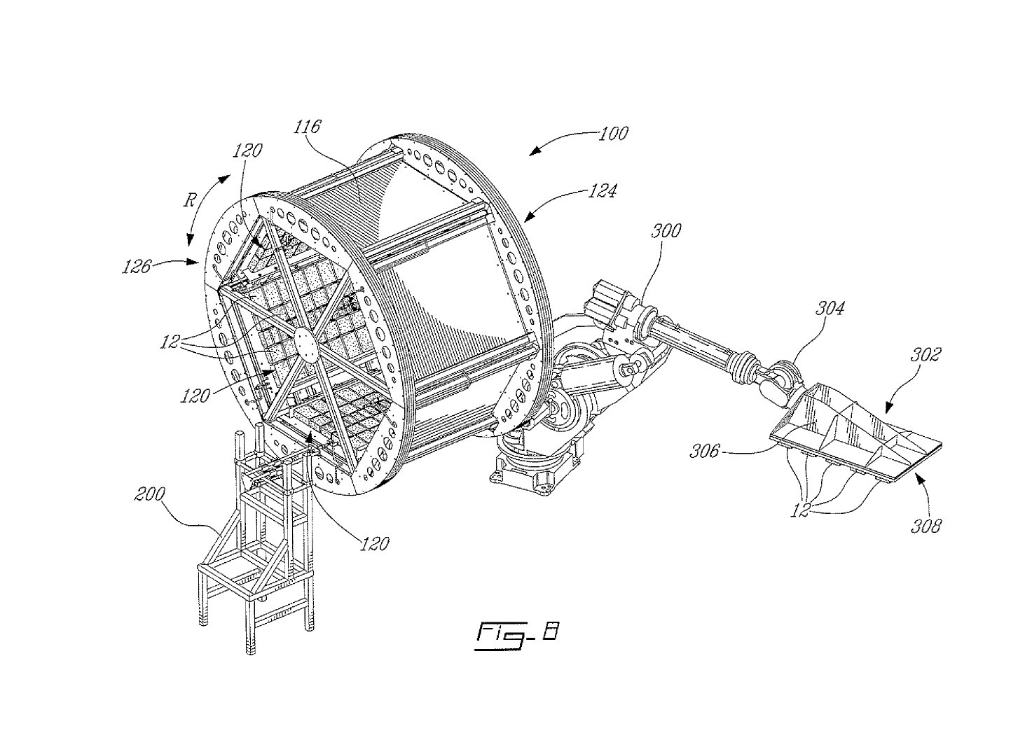

The blocks 12 are uploaded to (see FIGS. 5 and 6), and downloaded from (see FIGS. 7 and 8) the drum 116 via a robotic arm 300. In this illustrative example, the robotic arm 300 is a Fanuc™ M-900iA series robot, which is a six axes articulated robot well known in the art and therefore, for concision, need not be described any further.

A vacuum handle tool 302 is mounted to the wrist 304 of the robotic arm 300. The vacuum handle tool 302 acts as a platform for the blocks 12. The vacuum handle tool 302 includes a vacuum reservoir 306, a block receiving face 308 having openings 310 for the blocks 12. The openings 310 include gaskets (not shown) about their internal perimeters so as not to damage the blocks 12. Hence, the vacuum handle tool 302 via vacuum uploads, via suction, a group of cementitious blocks 12 following processing thereof.

As shown in FIG. 5, the robotic arm 300 moves the vacuum handle tool 302, with the blocks 12, into the drum 116 via an open lateral side 124 thereof. The drum 116 includes a plurality of block-receiving areas 120. The block receiving face 308 of the vacuum handle tool 302 is brought close to one of these block-receiving areas 120 at a time. Hence, the vacuum handle tool 302 suctions a group of blocks from an arranged column, level by level and fills in each block-receiving area 120 of the drum 116 as will be described herein.

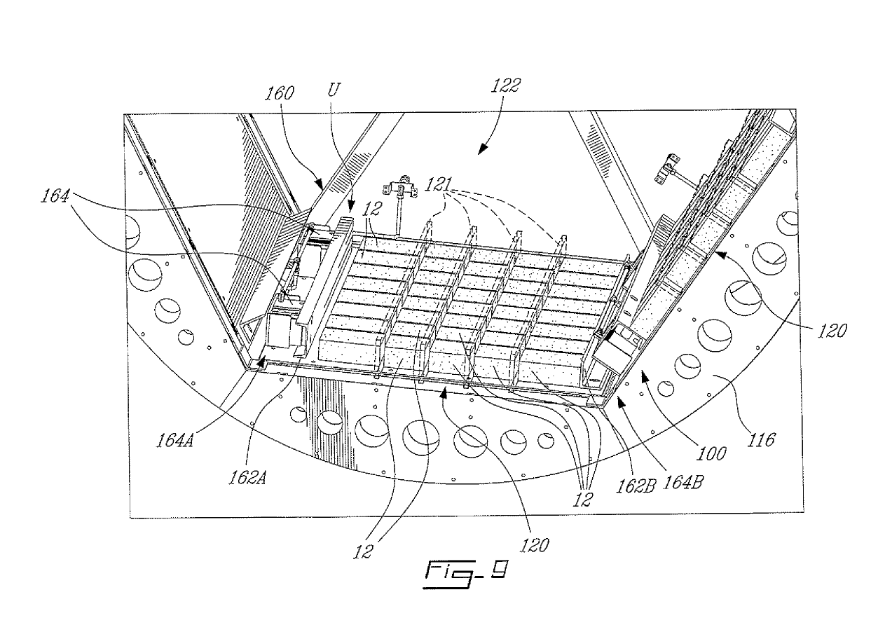

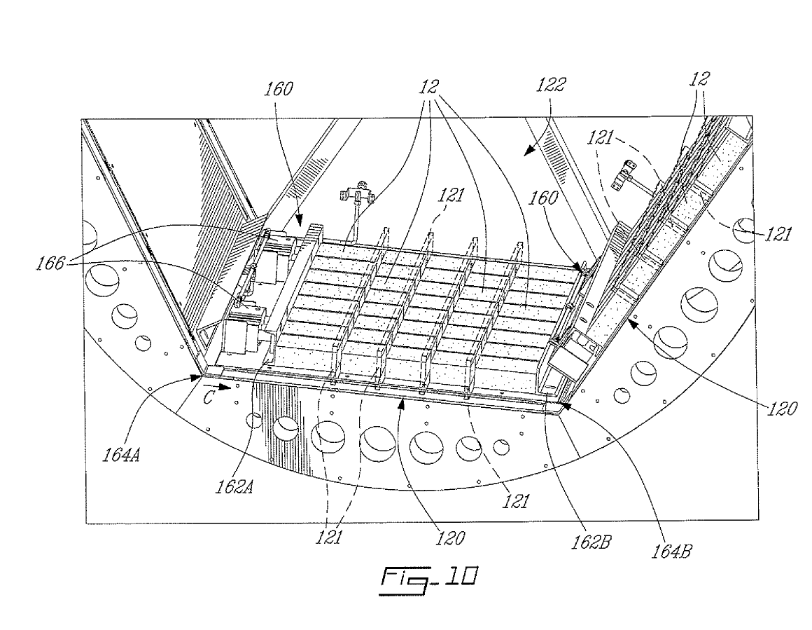

As shown in FIGS. 9 and 10, the block-receiving areas 120 include separators 121 in the form of longitudinal wall members. These wall members 121 can be made of a rigid compressible material for example. Hence, when each of the block-receiving areas 120 receives a group of blocks 12 from the vacuum handle tool 302 they are laid-out thereon in rows separated by the wall members 121. The wall member separators 121 are not necessary but convenient in maintaining the blocks 12 in position throughout the surface texture modifying operation. The disposition of the openings 310 is also helpful in maintaining the blocks 12 in their original arrangement from right after processing until the blocks are arranged for dispatching.

As shown in FIG. 7, the vacuum handle tool 302 brings a group of blocks 12 onto a given block-receiving areas 120, it then ceases its suction force in order to release the blocks 12 therefrom so that they can be received by this block-receiving areas 120.

Turning now to FIGS. 9 and 10, the tumbler 100 includes a plurality of block-immobilizing devices 160 in the form of clamping devices.

The clamping device 160 includes a pair of clamping members 162A and 162B at each lateral end 164A and 164B, respectively, of a block-receiving area 120. Clamping member 162A is operated by an actuator 166 in the form of pneumatic cylinders (to give but one example) so as to be moveable from an unclamping position U, shown in FIG. 9, to a clamping position C shown in FIG. 10. Clamping member 162B is an immovable member. Of course, either of, or both the clamping members 162A and 162B can be moveable and from an unclamping position U to a clamping position C.

When the blocks 12 are on the block-receiving area 120, the clamp member 162A is are activated by the pneumatic cylinders 166 to be moved towards the blocks 12. Clamp member 162A engages the row of blocks 12 at the lateral end 164A of the block-receiving area 120 and pushes the full group of blocks towards clamp member 162B. Clamp member 164B is engaged by the row of blocks 12 at the lateral end 164B of the block-receiving area 120 which are being forced thereon by the pressure of the moveable clamp 162A. The pressure applied to the foregoing lateral rows of blocks 12 acts on all the rows of blocks 12 therebetween, as well as the separators 121, to clamp the whole group of blocks 12 in place, via the fictional tension force provided by the pneumatic cylinders 164 between clamps 162A and 162B, thereby immobilizing the blocks 12 so that they be frictionally maintained in place as the drum 116 rotates.

Hence, as previously explained impacting material is inserted into the drum 116, the drum 116 is closed at each lateral side 124 and 126 and rotated, thereby causing the impacting material to tumble within the working space 122 (see FIGS. 9 and 10) and randomly impact the immobilized blocks 12 so as to modify the surface texture thereof.

Once the tumbling process is complete, the vacuum handle tool 302 enters the opened drum 116 and its block receiving face 308 is brought near to a given block-receiving area 120. The blocks 12 of the particular block-receiving area 120 are unclamped via the clamp members 162A and 162B moving to the unclamping position U (shown in FIG. 9). At this point, the vacuum handle tool 302 applies a suction force on the blocks 12 so that they be suctioned into openings 310 as shown in FIG. 7. The robotic arm 300 then moves the vacuum handle tool 302 out of the drum 116 so as to release the blocks 12 in predetermined arrangements for dispatch as shown in FIG. 8. This downloading process (illustrated in FIGS. 9, 7 and 8) repeats itself for each block-receiving area 120 having blocks 12.

Of course whether for block tumbler 100 or block tumbler 10, the blocks 12 can be re-loaded within these tumblers for further impacting. Since only one side of the blocks 12 is mostly expose to impacting material, the user may wish to have the opposite side impacted for surface modification thereof as well.

Also shown in FIGS. 5 to 8 is a ladder device 200 that provides access to tumbler 100.

The clamp members 162A and 164 may be provided in a variety of suitable sizes and configurations and may be powered by various actuators known in the art.

The block-immobilizing devices of the invention are not limited to clamping devices and vacuum devices, a variety of like mechanisms can be contemplated within the context of the present invention using various grasping instruments that can hold the blocks when actuated by an actuator. In another non-illustrated embodiment, a series of longitudinal elements which engage opposite lateral sides of the blocks 12 and then tighten to frictionally hold these blocks 12 during the tumbling operation can be used.

In another non-illustrated embodiment, the working areas 22 or 122 include an internal member for impacting the blocks 12 thereby enhancing the artificial ageing of the blocks 12. Therefore, in another embodiment, the impacting material may comprises this internal block-impacting member.

The various features of tumblers 10 and 100 illustrated and/or discussed herein can be combined in a variety of ways to provide other non-limiting embodiments within the scope of the present invention.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of embodiments thereof, it can be modified, without departing from the spirit, scope and nature of the subject invention as defined in the appended claims.

What is claimed is:

1. An apparatus for modifying the appearance of a surface-texture of cementitious blocks, said apparatus comprising:
a container comprising block-receiving areas for receiving blocks;
a movement imparting device for imparting a movement to said container; and
at least one block-immobilizing device for immobilizing blocks on a given said block-receiving area during movement of said container;
wherein when introducing an impacting material in said container and imparting said movement to said container the impacting material is caused to so impact the cementitious blocks as to modify the appearance of the surface texture thereof.

2. An apparatus according to claim 1, wherein said container comprises a rotatable drum.

3. An apparatus according to claim 1, wherein said movement imparting device comprises an actuator and belt assembly mounted to said container for rotational movement thereof.

4. An apparatus according to claim 1, wherein said block-receiving areas comprises a series of areas along the internal peripheral surface of said container.

5. An apparatus according to claim 1, wherein a said block-receiving area comprises separate compartments, each compartment configured to include a block therein.

6. An apparatus according to claim 1, wherein each said block-receiving area comprises separators for separating adjacent rows of blocks.

7. An apparatus according to claim 6, wherein said separators comprise longitudinal wall members.

8. An apparatus according to claim 7, wherein said wall members are made of rigid compressible material.

9. An apparatus according to claim 1, wherein said block-immobilizing device comprises a vacuum device.

10. An apparatus according to claim 8, wherein each said vacuum device comprises a suction mounted to said container so as to suction blocks into said block-receiving area.

11. An apparatus according to claim 10, wherein said block-receiving area comprises a plurality of compartments, said suction providing for a given block to be suctioned into a given said compartment.

12. An apparatus according to claim 10, wherein said vacuum device comprises a compressor operatively mounted to said suction.

13. An apparatus according to claim 1, wherein said block-immobilizing device comprises a clamping device.

14. An apparatus according to claim 13, wherein said clamping device comprises a pair of clamp members for clamping blocks therebetween.

15. An apparatus according to claim 14, wherein said each said clamping member is positioned at an opposite lateral side of a said block-receiving area.

16. An apparatus according to claim 14, wherein at least one of said clamp member is mounted to an actuator so as to be reciprocally moveable between a clamping position and an unclamping position.

17. An apparatus according to claim 16, wherein said actuator comprises a pneumatic cylinder.

18. An apparatus for modifying the appearance of a surface-texture of cementitious blocks, said apparatus comprising:
a container comprising block-receiving areas for receiving blocks;
a movement imparting device for imparting a movement to said container; and
at least one vacuum device for immobilizing blocks on a given said block-receiving area during movement of said container;
wherein when introducing an impacting material in said container and imparting said movement to said container the impacting material is caused to so impact the cementitious blocks as to modify the appearance of the surface texture thereof.

19. An apparatus according to claim 18, wherein said container comprises a rotatable drum.

20. An apparatus according to claim 18, wherein said vacuum device comprises a suction mounted to said container so as to suction blocks into said block-receiving area.

21. An apparatus according to claim 20, wherein said block-receiving area comprises a plurality of compartments, said suction providing for a given block to be suctioned into a given said compartment.

22. An apparatus according to claim 20, wherein said vacuum device comprises a compressor operatively mounted to said suction.

23. An apparatus for modifying the appearance of a surface-texture of cementitious blocks, said apparatus comprising:
a container comprising block-receiving areas for receiving blocks;
a movement imparting device for imparting a movement to said container; and
at least one clamping device for immobilizing blocks on a given said block-receiving area during movement of said container;
wherein when introducing an impacting material in said container and imparting said movement to said container the impacting material is caused to so impact the cementitious blocks as to modify the appearance of the surface texture thereof.

24. An apparatus according to claim 23, wherein said container comprises a rotatable drum.

25. An apparatus according to claim 23, wherein each said block-receiving area comprises separators for separating adjacent rows of blocks.

26. An apparatus according to claim 25, wherein said separators comprise longitudinal wall members.

27. An apparatus according to claim 26, wherein said wall members are made of rigid compressible material.

28. An apparatus according to claim 23, wherein said clamping device comprises a pair of clamp members for clamping blocks therebetween.

29. An apparatus according to claim 28, wherein said each said clamping member is positioned at an opposite lateral side of a said block-receiving area.

30. An apparatus according to claim 28, wherein at least one of said clamp members is mounted to an actuator so as to be reciprocally moveable between a clamping position and unclamping position.

31. An apparatus according to claim 30, wherein said actuator comprises a pneumatic cylinder.

32. A method for modifying the appearance of a surface-texture of cementitious blocks, said method comprising:
immobilizing blocks within a moveable container;
introducing an impacting material in the container; and
imparting a movement to the container so as to cause the impacting material to so impact the cementitious blocks as to modify the appearance of the surface texture thereof.
